(19) United States
(12) Patent Application Publication
(10) Pub. No.: US 2004/0032070 A1
(43) Pub. Date: Feb. 19, 2004

(54) Interior c-clamp's holing-device

(76) Inventor: Albert Genduso, West Palm Beach, FL (US)

Correspondence Address: Albert Genduso, 13782 Geranium Place, West Palm Beach, FL, 33414, US

(21) Appl. No.: 10/219,879

(22) Filed: Aug. 16, 2002

(51) Int. Cl. B25B 1/10

(52) U.S. Cl. 269/249

(57) ABSTRACT

An interior c-clamp's holding-device (10) for repairing violins, violas, cellos, string basses and other string instruments, comprising a housing (15) located at the bottom-end of a c-clamp (21). Said housing (15) having, through its (15) exterior walls, a horizontal and a vertical passage(s) bored though housing's (15) entire width and height, thus created a horizontal/vertical intersection inside the housing (15). Having inserted into the vertical passage an adjustable-needle (14) adapted to hold a repair-cleat (19), having inserted into the horizontal passage a needle-locking screw (17) adapted to hold the adjustable-needle (14). Needle-locking screw (17) having an eye-hole at one-end, and a needle-locking thumbscrew (16) at its (17) opposite end; having said eye-hole placed into the intersection and its (17) needle-locking thumbscrew (15) extends out on the housing's (15) exterior wall's side opening. Having the adjustable-needle (14) inserted up through the vertical passage, through its (17) ‘eye’-hole; then turning the needle-locking thumbscrew (16) clockwise pulls the adjustable-needle (14) against the housing's (15) interior wall: thus holds/locks it (14) at the height needed for the repair-cleat process. Turning needle-locking thumbscrew (16) counter-clockwise unlocks the adjustable-needle (14). Having the tip/point of the adjustable-needle (14) extend out at the housing's (15) top-opening, and its (14) bottom-end extends out at housing's (15) bottom-opening. According to the thickness of the repair-cleats, the adjustable-needle (14) is an regulated manually, raising or lowering its (14) bottom-end will raise or lower its (14) top-end. The repair-cleat is held on the tip/point (top-end) of the adjustable-needle (14) during repair-cleat process, having glue applied on the surface of the repair-cleat (19). The width of the base of the c-clamp (21) with the housing (15) corresponds to the width of the soundboard's original designed f-shaped holes (20), allowing the base of the c-clamp (21) with the housing (15) holding the repair-cleat (19) to pass freely through said f-shaped hole (20) into the interior of the instrument, to the crack needing the repair-cleat (19). Because the base of the c-clamp (21) with the positioning repair-cleat (19) is directly below the clamping-pad (13) alignment of the clamping-pad (13) over the crack on the visible exterior of the instrument will assure alignment of the positioned repair-cleat (19) over the crack on the not visible interior of the instrument. Turning the Thumb-turn (11) located at the top of the clamping-screw (12) lowers the clamping-pad (13) closing the c-clamp (21), thus glues the repair-cleat (19) over the crack on the interior of the instrument. When said glue has dried, the c-clamp (21) can be loosened disengaging the repair-cleat (19) from the tip/point of the adjustable-needle (14), then the c-clamp (21) with the housing (15) holding the adjustable-needle (14) can be removed through said f-shaped hole (20) having completed the interior repair. Present invention (10) eliminates the need to remove the soundboards (tops) of these string instruments to make said interior repairs, thereby reducing extensive time and labor costs for consumers.

### BACKGROUND

1. Field of Invention

This invention relates to an interior c-clamp's holding device, specifically a holding-device that will help consumers save many hundreds of dollars in the cost of repairs on their Violins, Violas, Cellos, String-Basses, and other string instruments.

2. Description of Prior Arts

In the past the only way to fix cracks or breaks in violins, violas, cellos, string basses, and other string instruments, was to separate the soundboard (the top of the instrument) from the rest of the instrument allowing access to the inter of the instrument: Commonly called “removing the top” or “opening the instrument”. Once the interior of the instrument is accessible any cracks, which are first glued from the exterior, can be accessed and ‘cleated’ from the interior of the instrument.

‘Cleats’ are small delicate reinforcing blocks of wood which are glued across the cracks from the inside of the instrument to keep the cracks from reopening or spreading any further.

The wood-grain of the cleat can be oriented, diagonally or perpendicular, across the cracks for maximum reinforcements. Little cracks need few little thin-cleats, while larger cracks need multiple larger thicker-cleats.

Most cracks that need repair go through the entire wood of the instrument, exterior and interior, but without removing the soundboard the glue can only be added from the exterior, and applying reinforcement cleats to the interior of the instrument are not always possible.

Removing the soundboards, however, also comes with an array of additional problems and exposes the instruments to additional accidents or damage including:

1. Ribs cracking or splitting

2. The edges of the soundboards splitting or splintering

3. Additional cracking in the soundboard

4. Movement of the ‘neck of the instrument’ causing a change to the alignment with the rest of the instrument

5. The need for new sound-posts and sound-posts alignments

6. Removing the soundboard (top) of the instrument is traumatic to the instrument

7. The list of problems and potential problems is extensive

8. Note: After having removed the soundboards, made the interior repairs, repaired the above ‘1 to 7’ additional problems, and replaced the soundboards: Creates an enormous increase in ‘time and labor costs’ to the consumer. Such repairs have been known to cost from hundreds to thousands of dollars.

However, if the interior cracks could be accessed and repair-cleats applied without removing the soundboards, then many, if not all, of the above additional problems could be avoided. The results would be:

1. Quick low-cost interior repairs

2. Less trauma to these instruments

3. Less time and labor costs to the consumer.

NOTE. To apply repair-cleats to the interior of these musical string instruments' cracks, without removing the soundboards can be done with my present invention: ‘Interior C-Clamp’s Holding-Device’.

Inventors have created many types of clamps and c-clamps such as:

Q1. U.S. Pat. No. 3,055,654 to Harrison (1962) “Screw clamp” Providing improved cooperating screw threads, which allow for efficient rapid adjustment and also maximum mechanical force advantages and efficient irreversible holding.

02. U.S. Pat. No. 3,066,931 to Beals (1962) “C-Clamp With Ratchet Action Screws” C-Camps designed to speed up the operation thereof by reducing the time now wasted in laboriously threading the clamp screw long distance both ways.

03. U.S. Pat. No. 3,147,003 to Johnson (1964) “Fast Action C-Clamp” Provision for means for locking the nut relative to the screw member in a fast action clamp . . . there is no possibility of the nut and screw rotating as to loosen the clamp when it is not desired.

04. U.S. Pat. No. 4,582,307 to Wang (1986) “C-Clamp” Provided with a threaded surface which can be rotated pivotally to engage or disengage with the screw, whereby one can determine a fast operation mode or a normal operation mode of the c-clamp.

05. U.S. Pat. No. 4,823,636 to Suska (1989) “Wrenchable C-Clamp” Is formed with a hexagonal portion coaxial with a clamping screw and sized to fit standard open end and box wrenches. A user can apply a wrench to the wrenchable portion to hold the c-clamp in a desired position while clamping screw is actuated.

06. U.S. Pat. No. 5,568,916 to Gibbons “Quick Set And Releace Clamping Device”. To provide a quick set and release clamping device which allows the user to freely move the threaded rod back and forth without having to turn the thread rod in and out.

07. U.S. Pat. No. 5,893,553 to Pinkous (1999) “Portable C-Clamp With Non-Rotatable Clamping Pad Means”. Has a blocking bar detachably secured to the upper pad to prevent rotation of the pad and has a swivel pad on the lower anvil means for engagement with the clamped article.

08. U.S. Pat. No. 6,029,964 to Bohl (2000) “Clamp With Swivel Pads” Relates to generally clamping apparatus and more particularly to an improved removable swivel pad for the gripping pads of the clamp.

09. U.S. Pat. No. 6,098,973 to Khachatoorian (2000) “C-Clamp” To allow the user to freely move the threaded rod portion of the device back and forth relative the clamping frame without having to rotate the threaded rod portion.

10. U.S. Pat. No. 6,113,089 to Kleinbongartz (2000) “Screw Clamp” To provide a screw clamp, in particular an all-steel screw clamp, which is more secure with respect to vibration.

11. U.S. Pat. No. 6,250,621 to Ping (2001) “Clamp” An improved clamp for clasping an article between an anvil and a striker head.

NEVERTHELESS, while all of the above clamps and c-clamps may excel in their original purpose, none have the unique interior c-clamp's holding-device (present invention) necessary to apply reinforcing repair-cleats across the cracks on the interior of these string instruments without removing the soundboards (tops) of these instruments.

The Interior C-Clamp's Holding-Device (present invention) is a holding-device located at the bottom-end of a c-clamp, able to apply repair cleats across the cracks on the interior of these string instruments without removing the soundboards (tops) of the instruments. Present invention can make said repairs through these string instruments' “original designed cut-outs” (openings) in the following manner:

Violins, Violas, Cellos, and String Basses, are all built fairly alike, with the Violin being the smallest to the String-Bass being the largest. On the surface of all their soundboards are ‘f-shaped cut-outs’ (known as ‘f-holes’) designed to allow air to move in and out producing musical sound from the strings to project from the instruments.

Through these f-shaped holes (and without disturbing these f-shaped holes) said interior repairs can be made with present invention: The width of the base of the c-clamp with the holding-device corresponds to the width of the above ‘f-shaped hole’, allowing the base of the c-clamp with the ‘holding-device to pass freely through the f-shaped hole, pass into the interior of the instruments.

### OBJECTS AND ADVANTAGES

The objects and advantages of present invention, as described in this patent application are:

a) To provide an Interior C-clamp's Holding-Device that will help avoid many, if not all, of the above additional problems caused and compounded by/in removing the soundboards (tops) of these string instruments.

b) To provide an Interior C-clamp's Holding-Device which can apply quick low-cost repair-cleats across the cracks to the interior of these musical string instruments, without removing the soundboards (tops) of these instruments.

c) To provide an Interior C-clamp's Holding-Device which is a hand-held tool needing no batteries or electric power, is simple in construction and inexpensive to manufacture.

d) To provide many advantages to our public schools and to our students in the following manner:

In our public schools' music classes: The musical string instruments that have been cast aside in need of costly repairs (removing the soundboards) can now be repaired with present invention's quick low-cost repair-cleats without removing the soundboards.

Present invention can repair, restore, and return said string instruments back into our public schools' music-study classrooms at ‘little time and labor cost’ Thus all students will have an equal opportunity to study music in their public schools.

The benefits and advantages, in public schools' music-study classes in which each student has his/her own musical instrument ‘in hand’ are many, including:

1. Will help eliminate boredom and escalate knowledge.

2. Will give all students an equal opportunity to study music in our public schools.

3. Will enable all students to participate in their schools' musical plays, concerts, and orchestras.

4. Will help prepare students who wish to make the ‘Music Profession’ their career.

e) Present invention can save public schools and consumers hundreds of dollars in repairs by avoiding, and possibly eliminating, the need to remove the soundboards (tops) of their musical string instruments, to repair cracks from the interior of these instruments.

f) Present invention is a hand-held tool, and can be produced in a variety of sizes: Violins need a small size, while String-Basses need a larger size.

NOTE: Although the Interior C-clamp's Holding-Device (present invention) is primarily designed for the above musical string instruments industries: Present invention can also be applicable to any and all other industries.

Still further objects and advantages will become apparent from the consideration of the ensuring description and drawings.

### DRAWING FIGS. 1, 2, 3, 3A, 4.

FIG. 1 shows profile of Interior C-clamp's Holding-Device

FIG. 2 shows ‘interior repair in progress’: shows bottom-end of the c-clamp, with present invention's ‘housing’ holding the repair-cleat, having entered into the interior of the musical string instrument through the soundboard's f-shaped hole, and having extended the bottom-end of the c-clamp, with the housing holding the repair-cleat, to the crack needing the repair-cleat; then closing the c-clamp, glues the repair-cleat to the underside of the crack on the interior of the instrument.

NOTE: FIG. 2 also shows the Top View, and the Side View, of said repair-cleats.

FIG. 3 shows enlarged view of the interior of the holding-device with its components inserted therein

FIG. 3A shows the Interior C-Clamp's Holding-Device with its ‘housing’ having a repair-cleat pressed down on the tip/point of the Adjustable-Needle, until the bottom of the repair-cleat rest on the rim of the Housing's top opening, without the tip/point of the adjustable-needle penetrating the top/surface of the repair-cleat.

FIG. 4 shows exploded view of the Holding-Device

### REFERENCE NUMERALS IN DRAWINGS

10. Present invention ‘Interior C-Clamp's Holding-Device’

11. Thumb-turn (for clamping screw)

12. Clamping Screw

13. Swivel clamping-pad with cork-bottom pad

14. Adjustable-Needle

15. Housing for holding-device

16. Needle-Locking Thumbscrew

17. Needle-Locking Screw with ‘eye’-hole

18. Soundboard (top of instrument)

19. Repair-cleat

20. Soundboard's f-hole (f-shaped-hole)

21. C-clamp

### SUMMARY

An Interior C-Clamp's Holding-Device (10) comprising a Housing (15) having an Adjustable-Needle (14) and a Needle-Locking-Screw (17) inside the Housing (15) said Housing (15) being the base-end the C-clamp (21).

Description—FIGS.: 1, 3, 4.

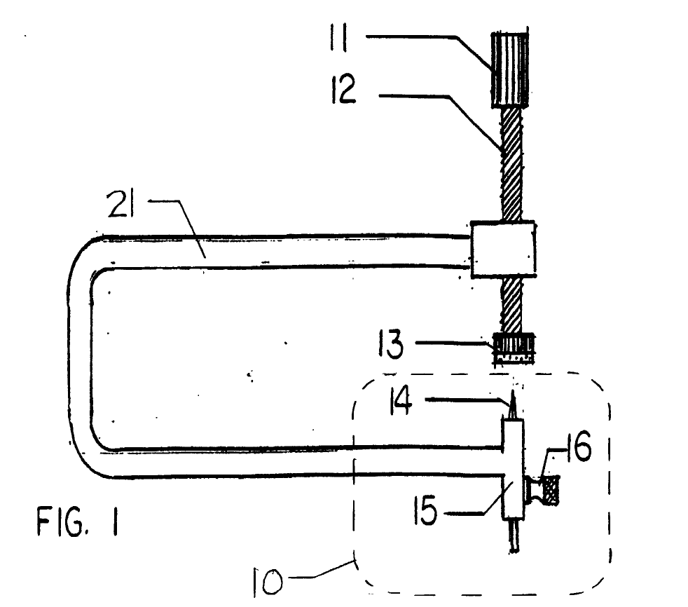

The typical embodiment of the Interior C-clamp's Holding Device (10) is illustrated in FIGS. 1, 3, 4.

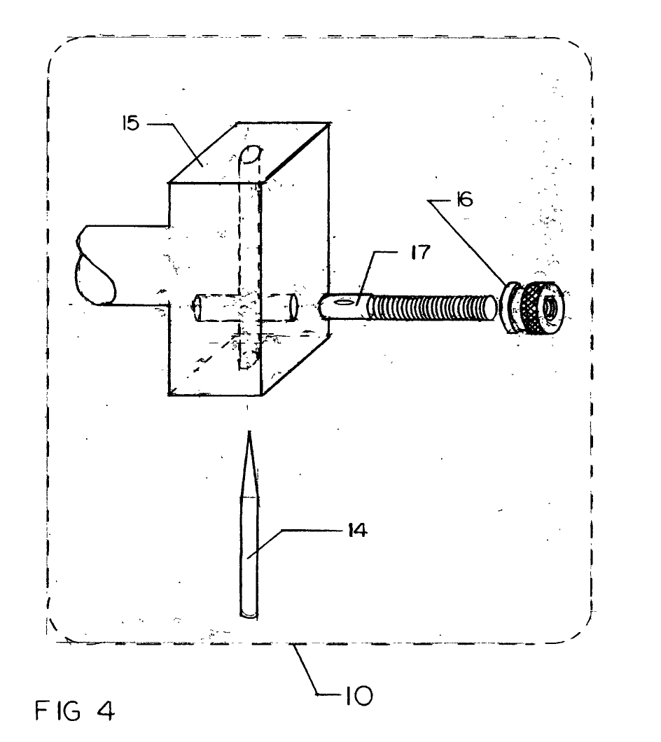

Present invention (10) is a holding-device having four components, of which only two are ‘moving parts’ FIG. 4

1. Housing (15)

2. Needle-Locking Screw (17)

3. Needle-Locking Thumbscrew (16) is a moving part

4. Adjustable-Needle (14) is the other moving part

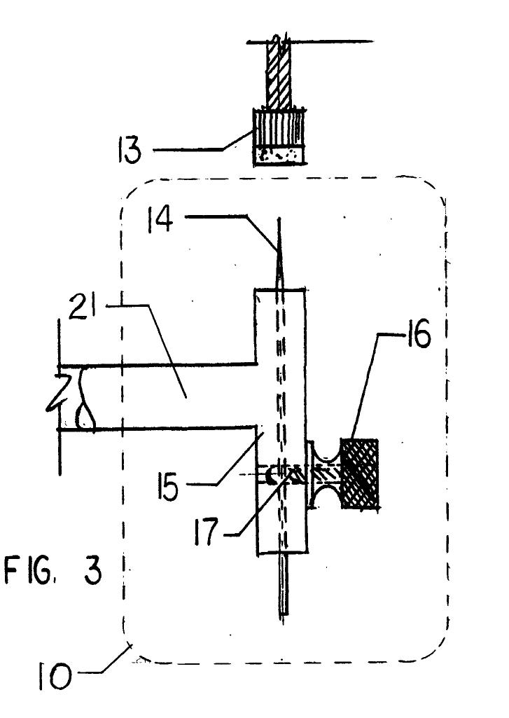

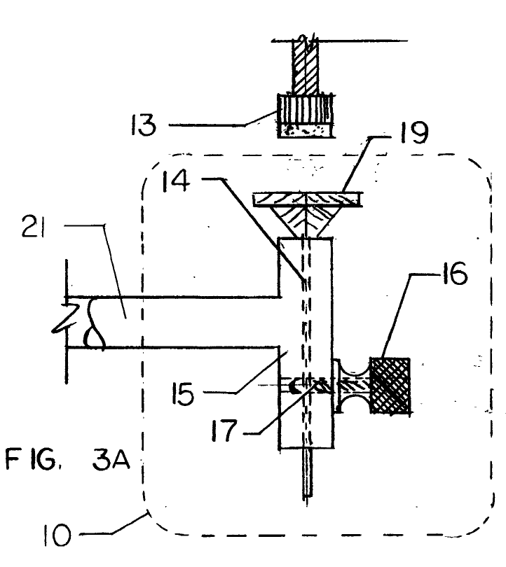

DETAILS OF THE ABOVE FOUR COMPONENTS: FIGS. 3 and 4

1. Housing (15) has a horizontal and a vertical passage(s) bored through Housing's (15) entire width and height, thus created a horizontal/vertical intersection inside the Housing (15). FIG. 4

2. Housing's (15) said horizontal and vertical passage(s) bored through its (15) exterior walls, provides top, bottom, and sides, exterior walls' openings through which to insert the Adjustable-Needle (14) and the Needle-Locking Screw (17). FIG. 4

3. Needle-Locking Screw (17) has an eye-hole at one end, and a Needle-Locking Thumbscrew (16) at its (17) opposite end. FIG. 4

4. Needle-Locking Screw (17) is inserted through said horizontal passage, with its (17) eye-hole placed into said intersection’, and the . . .

. . . . Needle-Locking-Thumbscrew (16) extends to the end of the horizontal passage, thus positioned out on the Housing's (15) exterior side-wall opening. FIGS. 3, 4.

5. Adjustable-Needle (14) is slightly taller than the Housing (15). FIGS. 1 and 3

6. Adjustable-Needle (14) is inserted up through the bottom opening of the Housing's (15) vertical passage, then it (14) passes up through the intersection/eye-hole (17), thus the tip/point of the adjustable-needle (14) extends up/out at the Housing's (15) top-opening. FIGS. 1 and 3

7. Adjustable-needle's (14) bottom-end extends out through the Housing's (15) bottom opening. FIGS. 1 and 3

From the description above a number of advantages of my present invention (10) become evident:

a) All of present invention's (10) above four components: Adjustable-Needle (14), Housing (15), Needle-Locking Thumbscrew (16), and Needle-Locking Screw (17), are all assembled at the bottom-end of the c-clamp during production at the factory. FIGS. 1, 3, 4.

b) Thus, present invention (10) is a near ‘ready to use’ product. Consumers need only to manually regulate the Adjustable-Needle (14), raise or lower, according to the thickness of the repair-cleat (19) thus it (10) is ready for work. FIGS. 1 and 3

c) Present invention (10) is user friendly, a simple handheld tool, needing no batteries or electric power to operate. FIGS. 1, 3, 3A, 2.

Operations FIGS. 1, 2, 3, 3A, 4.

1. Adjustable-Needle (14) is regulated manually, requires only to ‘raise or lower’ the bottom-end of the Adjustable-Needle (14) at the Housing's (15) bottom-opening, will ‘raise or lower’ the tip/point of the Adjustable-Needle (14) at the Housing's (15) top-opening. FIG. 3

2. Having regulated the Adjustable-Needle (14): Then by tightening (turning clockwise) the Needle-Locking Thumbscrew (16), the Adjustable-Needle (14) is pulled against the Housing's (15) interior wall, and held tightly (locked) in position during repair-cleat (19) process. Turning the Needle-Locking Thumbscrew (16) counter-clockwise unlocks the Adjustable-Needle (14) inside the Housing (15). FIG. 3

3. Each interior repair is make by pressing a repair-cleat (19) down on the tip/point of the Adjustable-Needle (14) until the underside of the repair-cleat (19) rests on the Housing's (15) top-rim, without having the tip/point of the Adjustable-Needle (14) penetrate the surface of the repair-cleat (19). Then glue is applied on the surface of the repair-cleat (19). FIG. 3A

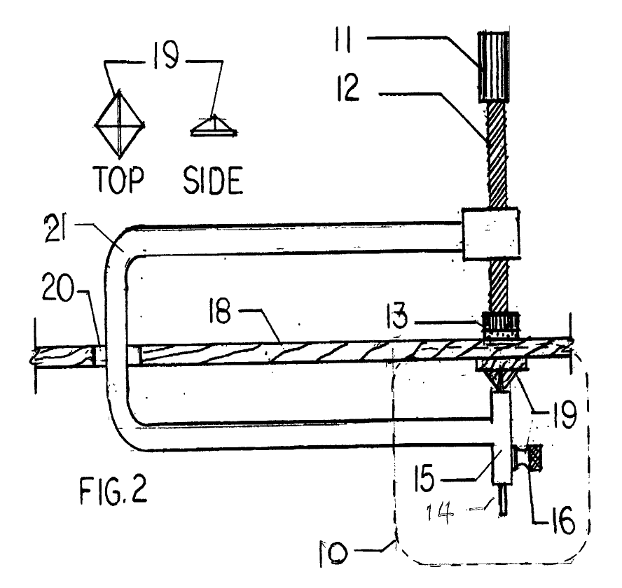

4. Then the base of the c-clamp (21), with the Housing (15) holding the Adjustable-Needle (14) with the repair-cleat (19), will be lowered through the soundboard's (18) f-shaped hole (20) into the instrument's interior, there the base of the c-clamp (21) will extend the Housing (15) to the crack where the repair-cleat (19) is needed. FIG. 2

5. Exact ‘position’ for each needed repair-cleat (19) is lightly marked (easily erasable), across the crack on the soundboard's (18) visible exterior (top surface) of the instrument. FIG. 2

6. Because the ‘positioning’ repair-cleat (19) is held directly below the clamping pad (13) of the c-clamp (21) alignment of the clamping pad (13) over the crack on the visible exterior of the instrument, will assure alignment of repair-cleat (19) over the crack on the not visible interior of the instrument. FIGS. 1, 3A, 2.

7. The Thumb-turn (11), located at the top of the clamping-screw (12), opens and closes the c-clamp (21). By gently closing the c-clamp (21) brings and glues the repair-cleat (19) across the underside of the crack on the interior of the instrument. FIGS. 1, 3A, 2.

8. When sufficient time has elapsed for the glue on the repair-cleat (19) to dry, the repair-cleat (19) will be secured to the underside of the crack. Then the c-clamp (21) can be loosened and lowered slightly to disengage the repair-cleat (19) from the tip/point of the Adjustable-Needle (14). FIGS. 2, and 3

9 Then the c-clamp (21) with the Housing (15) holding the Adjustable-Needle (14), can be removed out through the instrument's f-shaped-hole (20). The repair-cleat (19) reinforcement will be completed: “Without removing the soundboard (top) of the instrument.” FIGS. 2, 1.

NOTE: If the repair-cleat (19) is larger than the ‘f-shaped hole’ (19) then: First insert the lower portion of the c-clamp (21) with the Housing (15) holding the Adjustable-Needle (14), through the ‘f-shaped hole’ (20) into the interior of the instrument. Then, using a tweezers, lower the repair-cleat (19) through the ‘f-shaped hole’ (20) and position the repair-cleat (19) securely on the tip/point of the Adjustable-Needle (14) and proceed as stated above.

NOTE:

a) When the Adjustable-Needle (14) is regulated (lowered) to hold a thin-cleat’(19): as many as needed said thin-cleats'(19) repairs can be made in succession with that one-regulation for thin-cleats' (19). FIG. 3A

b) Likewise, when the Adjustable-Needle (14) is regulated (raised) to hold a ‘thick cleat (19): as many as needed said ‘thick cleats’ (19) repairs can be made in succession with that ‘one-regulation’ for ‘thick cleats’ (19). FIG. 3A

c) Seldom do these string-instruments' cracks require only one thin-cleat (19) repair, and only one thick-cleat (19) repair. Nevertheless, should the above happen: repeatedly regulating the Adjustable-Needle (14) (raised and lowered) manually, only takes a minute or two. FIG. 3A

d) All of which both simplifies and speeds up working on all, and each, thin and thick repair-cleats (19) without removing the soundboards (tops) of said musical string instruments. FIGS. 3A, 2.

Maintaining/Cleaning Interior C-Clamp's Holding-Device (10)

Occasionally, due to fine saw-dust particles and/or excess glue, present invention's (10) Housing (15) may need to be cleaned, all of which requires only four simple manual steps:

1. Turn the Needle-Locking Thumbscrew (16) counterclockwise to unlock the Adjustable-Needle (14) inside the Housing (15). FIG. 3

2. From the Housing's (15) bottom-opening: remove (pullout) the Adjustable-Needle (14). FIG. 3

3. By the Needle-Locking Thumbscrew (16): remove (pull-out) the Needle-Locking Screw (17). FIG. 4

Resulting with the Housing (15) now being completely empty.

4. Clean out the Housing's (15) horizontal and vertical passages, then polish the Adjustable-Needle (14), the Needle-Locking Screw (17, and the Needle-Locking Thumbscrew (16). FIG. 4

To Reassemble the Above: Reverse steps 1, 2, 3

1. (3). Insert the Needle-Locking Screw (17) inside the Housing's (15) horizontal passage, with its (17) eyehole placed into said horizontal/vertical intersection and, at the end of the horizontal passage, position the Needle-Locking Thumbscrew (16) outside on the Housing's (15) exterior side-wall. FIGS. 3, and 4

2. (2). Insert the Adjustable-Needle (14) up through the Housing's (15) vertical passage, then it (14) passes up through the intersection/eye-hole (17), the tip/point of the Adjustable-Needle (14) extends up/out at the Housing's (15) top-opening; and the bottom-end of the Adjustable-needle (14) extends out at the Housing's (15) bottom-opening. FIGS. 3, 4

3. (1). Turning the Needle-Locking Thumbscrew (16) clockwise locks the Adjustable-Needle (14) inside the Housing (15). FIG. 3

Thus maintenance/cleaning process is completed. FIGS. 4, 3, 1

### SUMMARY, RAMIFICATIONS, AND SCOPE

The reader will see that, without removing the soundboards (tops) of these musical-string instruments, present invention (10) can make said ‘interior repairs’ easily and conveniently without damage or disturbance to said Violins, Violas, Cellos, String-Basses, and other string instruments.

Therefore, present invention (10) can save consumers and public schools hundreds of dollars in extensive time-and labor cost in said repairs by avoiding, and possibly eliminating, the need to remove the soundboards (tops) of these musical string instruments to repair cracks from the interior of these string instruments.

In addition: Although the Interior C-clamp's Holding-Device (present invention) is primarily designed for the above musical string instruments industries: Present invention can also be applicable to any and all other industries. Therefore, said present invention can be produced/manufactured in multiple sizes, according to the needs of any and all other industries, thus according to the needs of the market place.

Present invention: Interior C-clamp's Holding-device (10) advantages include:

1. it is a hand held tool, user friendly, simple to use, quick and easy to clean, and needs no batteries or electric power to operate.

2. it is simple in construction and inexpensive to manufacture, thus it is economical, cost efficient, and attractive to investors, individuals consumers, private and public schools, and specific companies.

3. Nationwide, more utilization of present invention (10) will occur, resulting with and increasing number of public schools able to afford to have more music-classes for all students who wish to study music.

Although the description above contain many specifics, these should not be construed as limiting the scope or the invention but as merely providing illustrations of some of the present advantages of this invention.

The scope of this invention should be determined by the appending claims and their legal equivalents, rather than by the examples given.

I claim:

1. An interior c-clamp's holding-device for repairing violins, violas, cellos, string basses, and other string instruments, comprising a housing located at the bottom-end of a c-clamp, said housing having a horizontal and a vertical passage therein, thus resulting with a horizontal/vertical intersection inside the housing, inserted into the vertical passage an adjustable-needle adapted to hold a repair-cleat, inserted into the horizontal passage a needle-locking screw adapted to hold said adjustable-needle, said horizontal and vertical passages are bored through the housing's exterior walls, thus provides top, bottom, and sides, exterior walls' openings through which to insert said adjustable-needle and needle-locking screw.

2 An interior c-clamp's holding-device as claimed in claim 1, said needle-locking screw, has an eye-hole at one end and a needle-locking thumbscrew at the opposite end, is inserted into the horizontal passage, thus having the eye-hole placed into said intersection, and the needle-locking thumbscrew extends out on the housing's exterior wall's side opening.

4. An interior c-clamp's holding-device as clamed in claim 1 or 2, said adjustable-needle is inserted into said vertical passage, through said intersection/eye-hole, result: turning said needle-locking thumbscrew clockwise pulls the adjustable-needle against the housing's interior wall, thus holds/locks the adjustable-needle at the height needed for repair-cleat process, turning the needle-locking thumbscrew counter-clockwise unlocks the adjustable-needle; repair-cleats are small delicate reinforcing blocks of wood glued across the cracks on the interior of said instruments to keep the cracks from reopening or spreading further.

5. An interior c-clamp's holding-device as claimed in claim 1 or 3, the tip of the adjustable-needle extends out at housing's exterior wall's top-opening, and the bottom-end of the adjustable-needle extends out at the housing's exterior wall's bottom-opening.

6. An interior c-clamp's holding-device as claimed in claim 3 or 4, the adjustable-needle is regulated manually, raised or lowered, according to the thickness of the repair-cleat, raising or lowering the bottom-end of the adjustable-needle will raise or lower the tip/point of the adjustable-needle, the repair-cleat is held on the tip/point of the adjustable-needle during said repair process.

6. An interior c-clamp's holding-device as claimed in claim 1, the width of the c-clamp's base with the housing, corresponds to the width of the f-shaped holes designed into the string instruments' soundboards, thus the base of the c-clamp with the housing holding the repair-cleat, passes freely through the f-shaped-hole into the interior of the instruments, thus able to position the repair-cleat at the crack needing the repair-cleat.

7. An interior c-clamp's holding-device as claimed in claim 6, because the base of the c-clamp, with said positioned repair-cleat, is directly below the clamping-pad, alignment of said clamping-pad over the crack on the visible exterior of the instrument will assure alignment of the positioned repair-cleat over the crack on the not visible interior of the instruments, then closing the c-clamp, glues said positioned repair-cleat over the crack on the interior of the instrument.

8. An interior c-clamp's holding-device as claimed in claim 6, having allowed the glue on the repair-cleat to dry, the repair-cleat is secured to the crack, then the c-clamp can be loosened, thus disengaging the repair-cleat from the tip/point of the adjustable-needle, then the c-clamp, with said housing holding the adjustable-needle, can be taken out of the instrument through said f-shaped hole, having completed said interior repair.

9. An interior c-clamp's holding-device as claimed in claim 1 or 6, eliminates the need to remove the soundboards of violins, violas, cellos, string basses, and other string instruments, to access the interior of these string instruments to make said interior repairs, thereby reducing the extensive time and labor costs for consumes, and for public schools' music-classes needing said string-instruments repaired.
